(19) United States
(12) Patent Application Publication
(10) Pub. No.: US 2020/0117978 A1
(43) Pub. Date: Apr. 16, 2020

(54) SYSTEMS AND METHODS FOR EFFICIENTLY MAPPING NEURAL NETWORKS TO PROGRAMMABLE LOGIC DEVICES

(71) Applicant: ALIBABA GROUP HOLDING LIMITED, George Town (KY)

(72) Inventors: Guoyang CHEN, San Mateo, CA (US); Weifeng ZHANG, San Mateo, CA (US)

(73) Assignee: ALIBABA GROUP HOLDING LIMITED

(21) Appl. No.: 16/159,580

(22) Filed: Oct. 12, 2018

(51) Int. Cl. G06N 3/04; G06N 3/08

(52) U.S. Cl. CPC G06N 3/0454; G06N 3/08

(57) ABSTRACT

The present disclosure relates to computer-implemented systems and methods for efficiently mapping neural networks to programmable logic devices (PLDs). In one implementation, a method for mapping a neural network to an FPGA may include receiving a data structure defining an architecture of the PLD; receiving a data structure defining an architecture of the neural network; partitioning the architecture of the PLD into a plurality of layers, each layer having a starting primitive adjacent to a first off-chip buffer and an ending primitive adjacent to a second off-chip buffer; mapping the architecture of the neural network onto one or more of the plurality of layers such that a data transfer size is at least locally minimized; scheduling the mapped architecture of the neural network for execution on the one or more of the plurality of layers; and outputting an execution sequence based on the scheduled and mapped architecture of the neural network.

### TECHNICAL FIELD

The present disclosure relates generally to the field of neural networks and programmable logic devices. More specifically, and without limitation, this disclosure relates to computer-implemented systems and methods for efficiently mapping neural networks to programmable logic devices. The systems and methods disclosed herein may be used in various applications, such as a deep neural network (DNN) or other artificial neural networks (ANNs).

### BACKGROUND

Field-programmable gate arrays (FPGAs) and other programmable logic device (PLDs) are generally more efficient for execution of neural networks than conventional processing hardware, such as central processing units (CPUs), graphics processing units (GPUs), or the like. However, FPGAs and other PLDs often differ in architecture from each other and are usually custom designed to particular neural networks. Therefore, neural networks cannot be efficiently implemented on extant FPGAs and other PLDs that are not specifically designed for those neural networks.

### SUMMARY

In view of the foregoing, embodiments of the present disclosure provide computer-implemented systems and methods for efficiently mapping neural networks to existing PLDs. The systems and methods of the present disclosure may provide a technical solution to the technical problem of implementing new neural networks on existing PLD architectures. The systems and methods of the present disclosure may result in efficient spatial and temporal executions of neural networks on existing PLD architectures.

In some embodiments, a system for mapping a neural network to a programmable logic device (PLD) may comprise at least one memory configured to store instructions and at least one processor configured to execute the instructions to perform operations. The operations may comprise receiving a data structure defining an architecture of the PLD; receiving a data structure defining an architecture of the neural network; and partitioning the architecture of the PLD into a plurality of layers. Each layer may have a starting primitive adjacent to a first off-chip buffer and an ending primitive adjacent to a second off-chip buffer. The operations may further comprise mapping the architecture of the neural network onto one or more of the plurality of layers such that a data transfer size is at least locally minimized; scheduling the mapped architecture of the neural network for execution on the one or more of the plurality of layers; and outputting an execution sequence based on the scheduled and mapped architecture of the neural network.

In some embodiments, a method for mapping a neural network to a programmable logic device (PLD) may comprise receiving a data structure defining an architecture of the PLD; receiving a data structure defining an architecture of the neural network; and partitioning the architecture of the PLD into a plurality of layers. Each layer may have a starting primitive adjacent to a first off-chip buffer and an ending primitive adjacent to a second off-chip buffer. The method may further comprise mapping the architecture of the neural network onto one or more of the plurality of layers such that a data transfer size is at least locally minimized; scheduling the mapped architecture of the neural network for execution on the one or more of the plurality of layers; and outputting an execution sequence based on the scheduled and mapped architecture of the neural network.

In some embodiments, a non-transitory computer-readable storage medium may store a set of instructions that is executable by one or more processors to cause the one or more processors to perform a method for mapping a neural network to a programmable logic device (PLD). The method may comprise receiving a data structure defining an architecture of the PLD; receiving a data structure defining an architecture of the neural network; and partitioning the architecture of the PLD into a plurality of layers. Each layer may have a starting primitive adjacent to a first off-chip buffer and an ending primitive adjacent to a second off-chip buffer. The method may further comprise mapping the architecture of the neural network onto one or more of the plurality of layers such that a data transfer size is at least locally minimized; scheduling the mapped architecture of the neural network for execution on the one or more of the plurality of layers; and outputting an execution sequence based on the scheduled and mapped architecture of the neural network.

Additional objects and advantages of the present disclosure will be set forth in part in the following detailed description, and in part will be obvious from the description, or may be learned by practice of the present disclosure. The objects and advantages of the present disclosure will be realized and attained by means of the elements and combinations particularly pointed out in the appended claims.

It is to be understood that the foregoing general description and the following detailed description are exemplary and explanatory only, and are not restrictive of the disclosed embodiments.

### BRIEF DESCRIPTION OF THE DRAWINGS

The accompanying drawings, which comprise a part of this specification, illustrate several embodiments and, together with the description, serve to explain the principles and features of the disclosed embodiments. In the drawings:

FIG. 1 is a schematic representation of primitives in a field-programmable gate array (FPGA), according to embodiments of the present disclosure.

FIG. 2 is an exemplary system for mapping neural networks to FPGAs, according to embodiments of the present disclosure.

FIG. 3A is a schematic representation of a layer in an FPGA, according to embodiments of the present disclosure.

FIG. 3B is a schematic representation of another layer in an FPGA, according to embodiments of the present disclosure.

FIG. 4A is a schematic representation of a transformation of primitives prior to mapping a neural network to an FPGA, according to embodiments of the present disclosure.

FIG. 4B is a schematic representation of another transformation of primitives prior to mapping a neural network to an FPGA, according to embodiments of the present disclosure.

FIG. 4C is a schematic representation of yet another transformation of primitives prior to mapping a neural network to an FPGA, according to embodiments of the present disclosure.

FIG. 4D is a schematic representation of a fourth transformation of primitives prior to mapping a neural network to an FPGA, according to embodiments of the present disclosure.

FIG. 4E is a schematic representation of a fifth transformation of primitives prior to mapping a neural network to an FPGA, according to embodiments of the present disclosure.

FIG. 5 is a flowchart of an exemplary method for mapping a neural network to a field-programmable gate array (FPGA), according to embodiments of the present disclosure.

FIG. 6 is a depiction of an exemplary computer system for executing methods consistent with the present disclosure.

### DETAILED DESCRIPTION

The disclosed embodiments relate to computer-implemented systems and methods for mapping neural networks to field-programmable gate arrays (FPGAs) and scheduling execution of the same. Advantageously, the exemplary embodiments can provide improved efficiency over conventional acceleration of neural networks onto FPGAs. Embodiments of the present disclosure can also provide improved re-use of FPGAs with new neural networks structures.

Embodiments of the present disclosure may be implemented and used in various programmable logic devices (PLDs). Accordingly, although described in reference to field-programmable gate arrays (FPGAs), other PLDs such as programmable array logics (PALs), programmable logic arrays (PLAs), complex programmable logic devices (CPLDs), and the like may execute neural networks mapped and scheduled in accordance with the present disclosure.

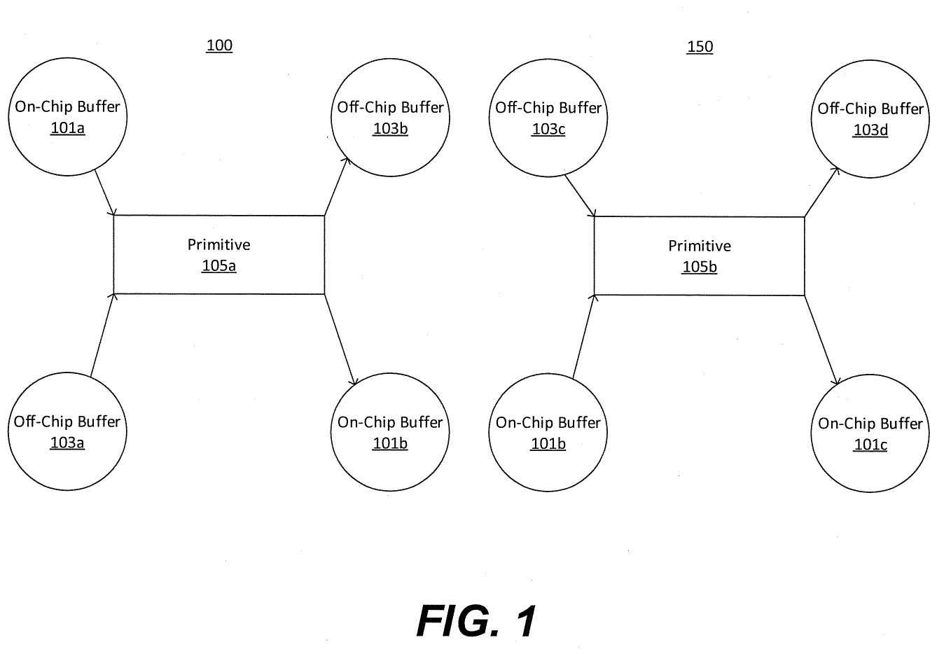

FIG. 1 is a schematic representation of exemplary pipelines (or portions of pipelines) 100 and 150 of an FPGA (or other PLD). As depicted in FIG. 1, a primitive 105a may connect to a plurality of data buffers, such as off-chip buffers 103a and 103b and/or on-chip buffers 101a and 101b. As used herein, a “primitive” refers to a node of the FPGA that performs a basic operation (whether logical, such as AND, OR, XOR, or the like, or arithmetic, such as multiply, add, subtract, max, min, or the like) on one or more inputs to produce one or more outputs. For example, in FIG. 1, primitive 105a may accept input from off-chip buffer 103a and/or on-chip buffer 101a and may output to off-chip buffer 103b and/or on-chip buffer 101b. As used herein, a “buffer” refers to any bus used to communicate data, such as a wire, an optical cable, or the like, along with any memory coupled to the bus and used to store (and thus “buffer”) the data and/or any arbiters or other timing hardware used to manage transfers on the bus.

Similar to primitive 105a, primitive 105b may accept input from off-chip buffer 103c and/or on-chip buffer 101b and may output to off-chip buffer 103d and/or on-chip buffer 101c. Accordingly, in the example of FIG. 1, primitive 105a may provide its output as input to primitive 105b using on-chip buffer 101b. Thus, primitive 105a and primitive 105b may be grouped as a subgraph of operations that flow from the operation(s) performed by primitive 105a to the operation(s) performed by primitive 105b. Embodiments of the present disclose may map neural networks (or other node-based applications) to primitives (such as primitive 105a and primitive 105b) of an FPGA (or other PLDs) to (at least locally) maximize in-chip transfers such as the transfer described above between primitive 105a and primitive 105b and (at least locally) minimize off-chip transfers (e.g., from primitive 105a to an off-chip memory and/or from primitive 105b to an off-chip memory).

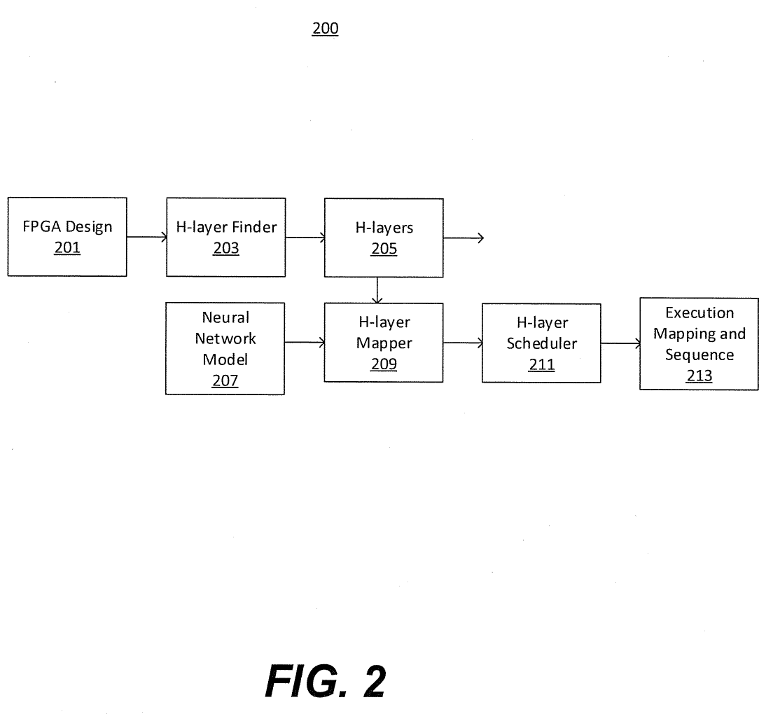

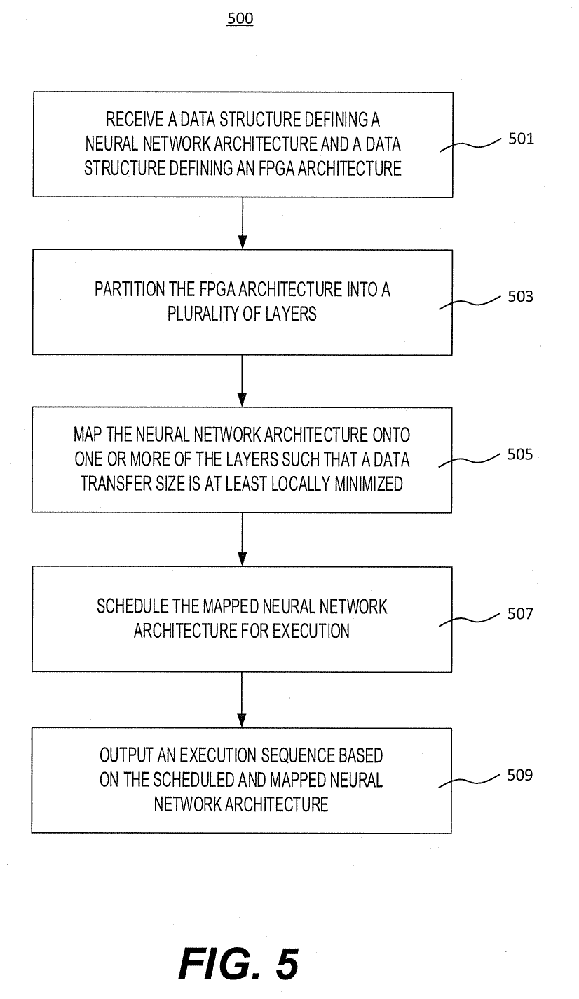

FIG. 2 is a schematic representation of a system 200 for mapping neural networks to FPGAs, consistent with embodiments of the present disclosure. As depicted in FIG. 2, an H-layer finder 203 (a “layer finder” hereafter) accepts an FPGA design 201 as an input, e.g., as described below in step 501 of method 500 of FIG. 5. For example, the FPGA design may comprise one or more data files in a specification language, such as Verilog, impulse C, the hardware specification language (HSL) described below with respect to FIG. 5, or other hardware description language (HDL). Layer finder 203 may thus determine the layers 205 of the FPGA architecture defined by FPGA design 201(e.g., as described below in step 503 of method 500 of FIG. 5). As used herein, a “layer” may refer to any sequence of primitives (also termed “nodes”) of the FPGA architecture that begins adjacent to an off-chip memory. In some embodiments, a “layer” may also end adjacent to an off-chip memory. The first off-chip memory adjacent to the beginning of a layer may comprise the same off-chip memory as the second off-chip memory adjacent to the ending of a layer or may comprise a different off-chip memory.

As further depicted in FIG. 2, an H-layer mapper 209 (a “layer mapper” hereafter) accepts layers 205 as an input as well as a neural network model 207 (e.g., as described below in step 501 of method 500 of FIG. 5). For example, layers 205 may comprise a data structure (such as an array or the like) defining the layers (also termed “paths”) determined by layer finder 203. Model 207 may comprise a data structure including the primitives and flow thereof that define the neural network. Layer mapper 209 may thus map primitives of model 207 to layers 205 of the FPGA architecture defined by FPGA design 201 such that an amount of data transfer for off-chip of the FPGA architecture is (at least locally) minimized. For example, layer mapper 209 may determine all possible mappings of model 207 onto layers 205 (e.g., as explained below in step 505 of method 500 of FIG. 5), and select the global minimum. Alternatively, layer mapper 209 may apply a greedy algorithm or other algorithm to find a mapping of model 207 onto layers 205 that is a local minimum.

In some embodiments, layer mapper 209 may output a data structure mapping primitives of model 207 to nodes of the FPGA architecture. Additionally or alternatively, the data structure generated by layer mapper 209 may serve as input for an H-layer scheduler 211 (a “layer scheduler” hereafter). Layer scheduler 211 may further determine an order in which the mapped primitives (e.g., the corresponding layers) are executed. For example, layer scheduler 211 may determine all possible schedulings of the mapped primitives (e.g., as explained below in step 507 of method 500 of FIG. 5), and select the global minimum. Alternatively, layer scheduler 211 may apply a greedy algorithm or other algorithm to find a scheduling of mapped primitives that is a local minimum.

Accordingly, layer scheduler 211 may output an execution sequence 213 defining both the mapping of model 207 to nodes of the FPGA architecture, and the order in which the primitives of model 207 are to be executed. For example, execution sequence 213 may comprise a bit stream of instructions for input to the FPGA chip to configure the FPGA chip to execute model 207.

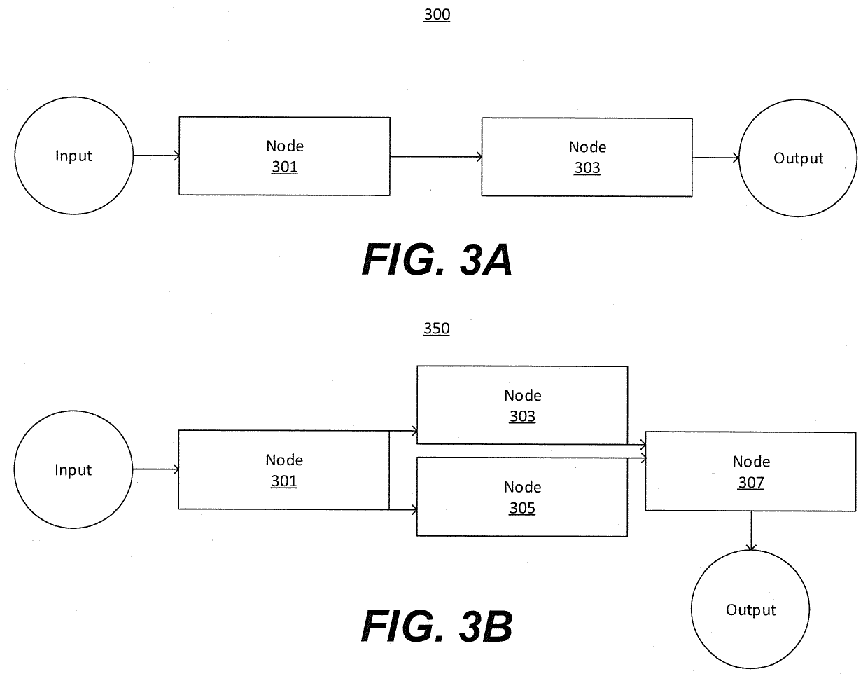

FIGS. 3A and 3B depict exemplary layers 300 and 350 that may be mapped from an FPGA (or other PLD). In the example of FIG. 3A, layer 300 includes two nodes (which may function as “primitives”), node 301 and node 303. In layer 300, input to node 301 produces output, which is the input to node 303 to produce the final output. As explained above, the input may begin at an off-chip memory (not shown). Additionally or alternatively, the output may end at an off-chip memory (not shown).

In the example of FIG. 3B, layer 350 includes four nodes (which may function as “primitives”), node 301, node 303, node 305, and node 307. As shown in FIGS. 3A and 3B, some nodes (e.g., nodes 301 and 303) may be members of multiple layers. In layer 350, input to node 301 produces output, which is the input to node 303 and to node 305 to produce outputs, which are the input to node 307 to produce the final output. As explained above, the input may begin at an off-chip memory (not shown). Additionally or alternatively, the output may end at an off-chip memory (not shown).

It is appreciated that the total number of layers for an FPGA is no greater than the sum of the partial permutations for all subsets of the nodes of the FPGA. In most embodiments, the total number of layers for an FPGA will be fewer than the sum of the partial permutations because very few FPGAs have all nodes connected to each other.

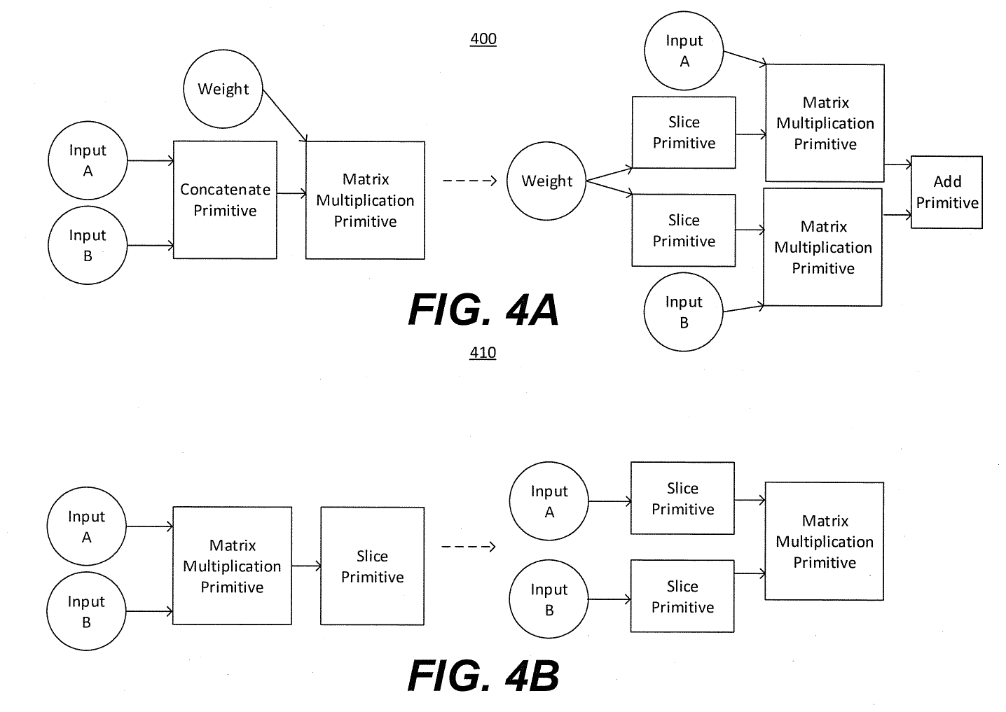

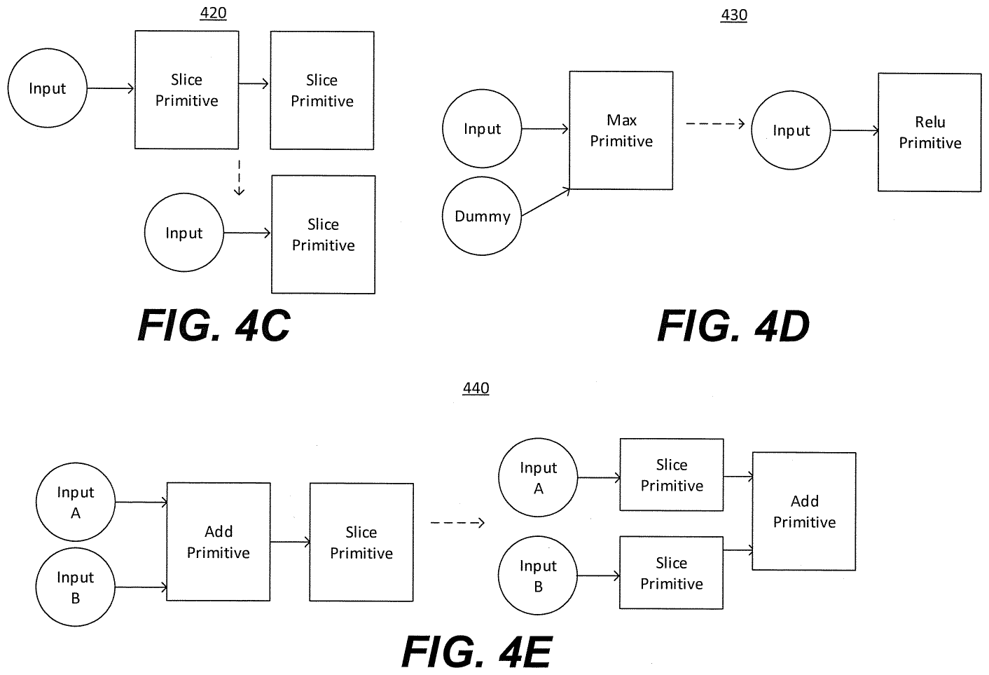

As explained above, embodiments of the present disclosure may perform one or more transformations on the neural network (or other nodal computational graph) prior to mapping the neural network to layers of an FPGA (or other PLD). FIGS. 4A-4E depict exemplary transformations 400, 410, 420, 430, and 440 that may be performed on a neural network prior to mapping to an FPGA. It is appreciated that FIGS. 4A-4E are only examples and that similar transformations may be performed in addition to or in lieu of those depicted in FIGS. 4A-4E.

In FIG. 4A, transformation 400 changes a concatenate primitive, followed by a matrix multiplication primitive into two slice primitives, two matrix multiplication primitives, and an add primitive. Similarly, in FIG. 4B, transformation 410 changes a matrix multiplication primitive, followed by a slice primitive into two slice primitives, followed by a matrix multiplication primitive.

FIGS. 4C-4E depict simpler transformations. For example, transformation 420 of FIG. 4C changes a slice primitive followed by a slice primitive into a single slice primitive. Similarly, transformation 430 of FIG. 4D changes a max primitive into a rectified linear unit (Relu) primitive. Transformation 440 of FIG. 4E changes an add primitive followed by a slice primitive into two slice primitives, followed by an add primitive.

The transformations of FIGS. 4A-4E may be defined using a specification language. For example, the transformations may be defined using a transformation specification language (TSL) as defined by the following syntax:

TSL:
transforms::=rule|rule transforms

rule::=name id comp transform_to comp;
comp::=val:value|variable begin end|primitive<comp*>
value::=any|int_var|(int_var*)
begin::=any|int_var|(int_var*)
end::=any|int_var|(int_var*)
name::=string
id::=integer
int_var::=integer|string
variable::=string

Keywords:
transform_to, val:, any, <>, primitive ∈ {dnn_compute_primitives};

In the specification above, each transformation specification describes the source and target computation patterns (that is, the primitive sequence to be replaced and the replacement primitive sequence). Each computation pattern consists of the computation primitive name(s) and corresponding input(s). As shown below for FIGS. 4A-4E, the computation pattern may be nested. For example, a valid computation pattern may comprise add<add<A,B>, C> where the second add is the 0^{th} input in the first add operation. The field “variable” represents that the input to the primitive may be from any other computation.

Accordingly, using TSL as defined above as an example, the transformations of FIGS. 4A-4E may be defined as below, respectively:
concat_eliminate 0 mm<concat<A (0 0) (m p) B (0 0) (m q) val:1>W (0 0) (x n)>transform_to add<mm<A (0 0) (m p) W (0 0) (p n)>mm<B (0 0) (m q) W (p 0) (x, n)>>
slice_mm 1 slice<mm<A (0 0) (m p) B (0 0) (p n)>val:(s t) val:(ss ts)>transform_to mm<slice<A (0 0) (m p) val:(s 0) val:(ss p) >slice<B (0 0) (p n) val:(0 t) val:(p ts)>>
slice_slice 2 slice<slice<A (0 0) (m n) val:(s1 t1) val:(ss1 ts1)>val:(s2 t2) val:(ss2 ts2)>transform_to slice<A (0 0) (m n) val:(s2 t2) val:(ss2 ts2)>
max_eliminate 3 max<A (0 0) (m n) val:0>transform_to relu<A (0 0) (m n)>
slice_add 4 slice<add<A (0 0) (in p) B (0 0) (p val:(s t) val:(ss ts)>transform_to add<slice<A (0 0) (m p) val:(s 0) val:(ss p)>slice<B (0 0) (p n) val:(0 t) val:(p ts)>>

In the specification above, each transform_to function changes the primitives defined on the left (and presumably within a neural network or other nodal computational graph) to the primitives defined on the right.

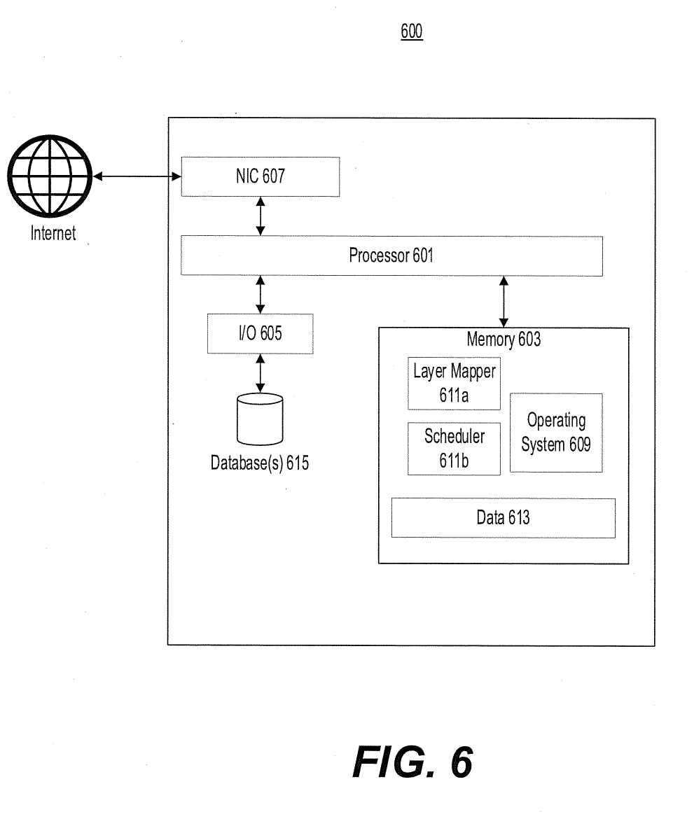

FIG. 5 is a flowchart of an exemplary method 500 for mapping a neural network to a field-programmable gate array (FPGA). Method 500 may be performed by at least one processor (e.g., processor 601 of system 600 of FIG. 6). Although described using an FPGA, method 500 may apply to any programmable logic device (PLD), such as a PAL, a PLA, a CPLD, or the like.

At step 501, the at least one processor may receive a data structure defining an architecture of the FPGA. For example, the data structure defining the architecture of the FPGA may comprise a specification language. For example, the language may comprise Verilog, impulse C, or any other HDL. In some embodiments, the data structure may comprise a hardware specification language (HSL) as defined by the following syntax:

HSL:
FPGAboard::=kernel* mem*
kernel::=name id (dnn_primitives*) InputBuffers OutputBuffers comp_constraints;
dnn_primitives::=bp_primitive*|(dnn_primitives)| {dnn_primitives}
bp_primitive::=primitive:bp|primitive:nbp
InputBuffers::=(Input:id mem_name)*
OutputBuffers::=(Output:id mem_name)*
comp_constraints::=constraint|constraint comp_constraints
constraint::={input_id cons_category RELATION [typeVal|shapeVal| dataVal]}
cons_category::=type|shape|data
typeVal::=any|char|bool|int8|int16|int32|int64|float16|float32|float64
shapeVal::=any|integer|(integer, integer)
dataVal::=any|integer|(integer, integer)
mem::=name id loc rw size (mem_name*);
name::=string
mem_name::=string
input_id::=integer
id::=integer
loc::=OnChip|OffChip
rw::=R|W|RW
size::=integer [B|KB|MB|GB|TB]

Keywords:
any, type, shape, data, R, W, RW, B, KB, MB, GB, TB, OnChip, OffChip, Input:, Output:,
:bp, :nbp, ( ), {}, primitive ∈ {dnn_compute_primitives}, RELATION ∈ {<, >, <=, >=, ==, !=};

In the specification above, a data structure defining an FPGA consists of a list of kernels and a list of memories. Each kernel corresponds to a computing logic (also termed “node” above) of the FPGA. Fields “name” and “id” indicate the name of the kernel and a unique identifier associated therewith, respectively. The field “dnn_primitives” comprises a list of one or more primitives, defining the primitives that are performable by the kernel. The execution order of the primitives may be pre-defined or may be arbitrary. Moreover, primitives performable by the kernel may be bypass-able or non-bypass-able (defined by “:bp” or “:nbp,” respectively). The field “InputBuffers” indicates the buffers that may input to the kernel, and the field “OutputBuffers” indicates the buffers to which the kernel may output.

Some kernels may have requirements for the size and/or the shape of inputs. Accordingly, the field “comp_constraints” may include a list of constraints describing requirements for the inputs. The “input_id” field identifies which input is constrained, the “cons_category” field defines the category of the constraint (e.g., type, shape, data, or the like), the “RELATION” field expresses the relationship between input and a target requirement, and the “typeVal|shapeVal|dataVal” field defines the target requirement(s). A kernel may have target requirements for only some inputs or may have different requirements for difference inputs. There is no limit on the number of constraints that may, in theory, be imposed on the different inputs.

In one example, an FPGA architecture may be defined using HSL as follows:

kernel0 0 (mm:bp) (Input:0 Buffer2) (Input:1 Buffer3);

kernel1 1 ({bias:bp add:bp} pooling:bp) (Input:0 Buffer1) (Input:1 Buffer2) (Input:2 Buffer2);

Buffer0 0 OnChip RW 1 MB {Buffer3};

. . . . . .

DDR 5 OffChip RW 1 GB {Buffer4 Buffer2};

In the specification above, the FPGA has at least two kernels, at least one buffer, and at least one dynamic random access memory (that is, an off-chip double data rate (DDR) memory). One of ordinary skill will recognize that the above specification is exemplary only and that an FPGA (or other PLD) may include any number of kernels, buffers, and off-chip memories. Additionally, an FPGA (or other PLD) may include any number of on-chip memories in addition to or in lieu of the off-chip memories.

Furthermore, at step 501, the at least one processor may receive a data structure defining an architecture of the neural network. For example, the data structure defining the architecture of the neural network may comprise a computational graph. In such an example, the computational graph may comprise a plurality of primitives and inputs thereto. Accordingly, the computation graph may be nodal. In some embodiments, the computational graph may include at least one nested pattern, as described above.

At step 503, the at least one processor may partition the architecture of the FPGA into a plurality of layers. For example, each layer may have a starting primitive adjacent to an off-chip buffer and an ending primitive adjacent to an off-chip buffer. In some embodiments, partitioning the architecture of the FPGA may comprise applying Dijkstra's algorithm. For example, Dijkstra's algorithm may extract possible paths through the nodes of the FPGA and may be applied to each possible starting node (e.g., adjacent to an off-chip buffer) in order to extract possible paths starting from each node (or at least from each node qualifying as a starting node).

Additionally or alternatively, partitioning the architecture of the FPGA may comprise generating possible paths along primitives of the FPGA that start and end adjacent to a bus transferring data off-chip, each path comprising one of the plurality of layers. For example, Dijkstra's algorithm, the Bellman-Ford algorithm, or any other algorithm suitable for generating possible paths may be applied.

Accordingly, in some embodiments, all possible paths through nodes of the FPGA may be computed. In other embodiments, a subset of possible paths through nodes of the FPGA may be computed. For example, a maximum number of nodes per layer may be applied such that all paths over a particular length are excluded. Additionally or alternatively, a minimum number of nodes per layer may be applied such that all paths under a particular length are excluded.

At step 505, the at least one processor may map the architecture of the neural network onto one or more of the plurality of layers such that a data transfer size is at least locally minimized. For example, the at least one processor may determine the data transfer size associated with each mapping based on outputs to and inputs from one or more off-chip memories of the FPGA.

Mapping the architecture of the neural network onto one or more of the plurality of layers may comprise generating possible mappings of primitives of the neural network onto the plurality of layers and selecting the possible mapping having a local minimum of the data transfer size. In some embodiments, the at least one processor may determine all possible mappings of subgraphs of the neural network to the layers of the FPGA and select the global minimum. In other embodiments, the at least one processor may determine a subset of possible mappings of subgraphs of the neural network to the layers of the FPGA and select the local minimum. For example, the at least one processor may apply a branch-and-bound algorithm or other tree-based algorithms, the Broyden-Fletcher-Goldfarb-Shanno (BFGS) algorithm or other quasi-Newtonian algorithms, or a combination thereof.

At step 507, the at least one processor may schedule the mapped architecture of the neural network for execution on the one or more of the plurality of layers. For example, the at least one processor may determine the data transfer size associated with each scheduling based on outputs to and inputs from one or more off-chip memories of the FPGA.

Scheduling the mapped architecture of the neural network for execution may comprise selecting an execution order for the one or more of the plurality of layers such that the data transfer size is at least locally minimized. For example, selecting the execution order may comprise generating possible execution orders of the one or more of the plurality of layers and selecting the possible execution order having a local minimum of the data transfer size. In some embodiments, the at least one processor may determine all possible schedulings and select the global minimum. In other embodiments, the at least one processor may determine a subset of possible schedulings and select the local minimum For example, the at least one processor may apply a greedy algorithm or other algorithm for determining a local maximum.

At step 509, the at least one processor may output an execution sequence based on the scheduled and mapped architecture of the neural network. For example, the execution sequence may comprise a bit stream for input to the FPGA (or other PLD). Accordingly, the at least one processor may output the bit stream directly to the FPGA to configure it accordingly. Additionally or alternatively, the at least one processor may output the bit stream for storage.

Method 500 may allow for execution of partial writes to off-chip memory if on-chip memory is insufficient. Accordingly, in some embodiments, at least one step of the execution order may comprise a partial write to off-chip memory and a partial write to on-chip memory.

Consistent with the present disclosure, the example method 500 may include additional steps. For example, in some embodiments, method 500 may include transforming at least one subgraph comprising one or more primitives to at least one other subgraph according to one or more transformation rules. For example, any or all of the transformations depicted in FIGS. 4A-4E may be used, additionally with or alternatively to similar transformations. In some embodiments, the transformation may be performed prior to step 505 or prior to step 503.

FIG. 6 is a depiction of an example system 600 for mapping neural networks to FPGAs, consistent with embodiments of the present disclosure. Although depicted as a server in FIG. 6, system 600 may comprise any computer, such as a desktop computer, a laptop computer, a tablet, or the like, configured to execute, for example, method 500 of FIG. 5.

As depicted in FIG. 6, server 600 may have a processor 601. Processor 601 may comprise a single processor or a plurality of processors. For example, processor 601 may comprise a CPU, a GPU, a reconfigurable array (e.g., an FPGA or other ASIC), or the like.

Processor 601 may be in operable connection with a memory 603, an input/output module 605, and a network interface controller (NIC) 607. Memory 603 may comprise a single memory or a plurality of memories. In addition, memory 603 may comprise volatile memory, non-volatile memory, or a combination thereof. As depicted in FIG. 6, memory 603 may store one or more operating systems 609, a layer mapper 611a, and scheduler 611b. For example, layer mapper 611a may include instructions to map neural network architectures to FPGA architectures (e.g., as explained in step 505 of method 500 of FIG. 5), and scheduler 611b may include instructions to schedule execution of a mapped neural network architecture (e.g., as explained in step 507 of method 500 of FIG. 5). Therefore, layer mapper 611a and scheduler 611b may cooperate with the hardware of FIG. 6 to perform method 500 of FIG. 5.

Input/output module 605 may store and retrieve data from one or more databases 615. For example, database(s) 615 may include neural network architectures and/or FPGA architectures, as described above.

NIC 607 may connect server 600 to one or more computer networks. In the example of FIG. 6, NIC 607 connects server 600 to the Internet. Server 600 may receive data and instructions over a network using NIC 607 and may transmit data and instructions over a network using NIC 607. Moreover, server 600 may receive data files defining neural network architectures or FPGA architectures over a network using NIC 607, as described above.

### EXAMPLE

Multiple simulations were developed and executed in order to demonstrate potential efficiency gains by using the disclosed techniques for mapping neural networks to FPGAs. The simulations used the disclosed transformation as described above and in the example pseudocode below:

| | |
|---|---|
| 1 | transform = { } |
| 2 | for rule ∈ R do |

| | |
|---|---|
| 3 | leftgraph = generateGraphFrom(rule.left); |
| 4 | rightgraph = generateGraphFrom(rule.right); |
| 5 | transform[leftgraph] = rightgraph; |

| | |
|---|---|
| 6 | end |
| 7 | //depth first search the graph and meanwhile transform the graph |
| 8 | worklist = [G−>rootNode]; |
| 9 | while worklist.notEmpty( ) do |

| | |
|---|---|
| 10 | node = worklist.pop_back( ); |
| 11 | replaced = false; |
| 12 | for t ∈ transform.keys( ) do |

| | |
|---|---|
| 13 | if replaceNodesIfMatched(node, t, G, &worklist, |
| | &transform) |

then

| | |
|---|---|
| 14 | replaced = true; |
| 15 | break; |

| | |
|---|---|
| 16 | end |
| 17 | if !replaced then |

| | |
|---|---|
| 18 | node−>visited = true; |
| 19 | for innode ∈ node−>incomingNodes( ) do |

| | |
|---|---|
| 20 | worklist.push_back(innode); |

| | |
|---|---|
| 21 | end |

| | |
|---|---|
| 22 | end |
| 23 | return G; |

In the pseudocode above, input R comprises transformation rules, input G comprise the computation graph for the neural network, and G is modified according to R and then output. In particular, lines 1-6 create a hashmap for mapping from graph pattern (e.g., an input subgraph in rule R) to another (e.g., an output subgraph in rule R). Lines 8-22 traverse the input graph G in a depth first manner. To keep track of the next nodes (that is, primitives) to be traversed, the pseudocode creates a worklist that initially only contains the root node of graph. At Line 10, the last element in the worklist will be visited. Lines 12-16 compare the subgraph dominated by the current node against all the transformation rules. If one of the rules is matched, the subgraph will be replaced and the consumer nodes of the root node of the new subgraph will be added to the worklist for visiting (see line 13). If none of the transformation rules are matched, then the consumer nodes of the current node will be added to the worklist (see lines 17-22).

The simulations further used the disclosed layer finder as described above and in the example pseudocode below:

| | |
|---|---|
| 1 | Mems, Kernels = preprocess(HSL); |
| 2 | //Collect the information if data in mema can be transfered to memb; |

MemReachable[mema][memb];

| | |
|---|---|
| 3 | MemReachable[Mems.size( )][Mems.size( )] = false; |
| 4 | MemReachable = process(Mems); |
| 5 | //Collect all the possible starting points of computation pipelines; |
| 6 | StartKernels = [ ]; |
| 7 | for k in Kernels do |

| | |
|---|---|
| 8 | for input in k.inputs do |

| | |
|---|---|
| 9 | if !MemReachable[DDR.id][input.id] then |

| | |
|---|---|
| 10 | break; |

| | |
|---|---|
| 11 | end |
| 12 | StartKernels.push_back(k.id); |

| | |
|---|---|
| 13 | end |
| 14 | //Generates all the possible computation pipelines using depth-first |

search among all the kernels;

| | |
|---|---|
| 15 | Pipelines = [ ]; |
| 16 | for k in StartKernels do |

| | |
|---|---|
| 17 | FindPipelines(k, &MemReachable, &Pipelines); |

| | |
|---|---|
| 18 | end |
| 19 | return Pipelines; |

In the pseudocode above, input HSL comprises a specification language defining the architecture of the FPGA and output Pipelines defines the layers of the FPGA. In particular, line 1 collects the basic memory and kernel components of the FPGA from the HSL. Line 4 uses Dijkstra's Algorithm with some modifications to fill two-dimensional array MemReachable with True or False, which indicates if there is a data movement path from one type of memory to another. Lines 7-13 try to collect all the kernels having input data that is from the off-chip memory. These StartKernels are candidates of the start primitive in a computation pipeline. Lines 16-18 start from every kernel in the StartKernels and use FindPipelines to look up all the kernels on the device and collect all the possible pipelines by checking the reachability from the memory to which one kernel writes to the memory from which another kernel reads.

The simulations also used the disclosed layer mapper as described above and in the example pseudocode below:

Main( ):

| | |
|---|---|
| 1 | Layers=[ ]; MinLayers = [ ]; Visited = {False}; |
| 2 | for node in G.ReadyNodes do |

| | |
|---|---|
| 3 | OneLayer = [ ] |
| 4 | LayerMapper(Pipelines, node, G.ReadyNodes, OneLayer, |

Layers, Visited, &MinLayers);

| | |
|---|---|
| 5 | end |
| 6 | return *MinLayers; |

LayerMapper( ):

| | |
|---|---|
| 1 | Status s = Pipelines.nextCanBe(node); |
| 2 | //0x00: INVALID; 0x01: CONTINUE on existing pipeline; 0x10: |

START a new pipeline; 0x11: BOTH CONTINUE and START are OK;

| | |
|---|---|
| 3 | if s & CONTINUE then |
| 4 | //CONTINUE/BOTH |
| 5 | OneLayer.push_back(node); Visited[node]= True; |
| | NextNodes.remove(node); |
| 6 | if NextNodes.size( ) == 0 then |

| | |
|---|---|
| 7 | check validity of the new pipeline and update *MinLayers if the |

data transfer is less. return;

| | |
|---|---|
| 8 | else |

| | |
|---|---|
| 9 | if node−>NumConsumers( ) == 1 then |

| | |
|---|---|
| 10 | Pipelines.setNext(node); NextNodes.addnew(node− |

>Consumers( )); //only add not visited nodes

| | |
|---|---|
| 11 | LayerMapper(Pipelines, node−>NextConsumer( ), |

NextNodes, OneLayer, Layers, Visited, MinLayers);

| | |
|---|---|
| 12 | else |

| | |
|---|---|
| 13 | if Pipelines.verify(OneLayer) then |

| | |
|---|---|
| 14 | Layers−>push_back(OneLayer); OneLayer = [ ]; |

Pipelines.reset( );

| | |
|---|---|
| 15 | NextNodes.addnew(node−>Consumers( )); //only add |

not visited nodes

| | |
|---|---|
| 16 | for n in NextNodes do |

| | |
|---|---|
| 17 | LayerMapper(Pipelines, n, NextNodes, |

OneLayer, Layers, Visited, MinLayers);

| | |
|---|---|
| 18 | end |

| | |
|---|---|
| 19 | end |

| | |
|---|---|
| 20 | end |
| 21 | if s & START then |

| | |
|---|---|
| 22 | ... |

| | |
|---|---|
| 23 | return; |

In the pseudocode above, input G comprises a computational graph (e.g., as transformed in accordance with the pseudocode above), input Pipelines defines the layers of the FPGA, and output Layers defines the graph G as mapped onto Pipeline. In particular, the loop at line 2 iterates the ready nodes as the start point of LayerMapper function. In the subroutine LayerMapper( ) the function call at line 1 checks if current node can be the next node in a layer based on the current data structure pipelines. There are four statuses for the results of this checking: 1) INVALID; 2) CONTINUE; 3) START; and 4) BOTH. INVALID means the current node cannot be in the current layer or in a new layer, which means this mapping cannot proceed further. CONTINUE means the current node can be a next node in one or more possible pipelines. START means the current node can be the start node in a new pipeline. BOTH means the current node satisfies the conditions of both CONTINUE and START. CONTINUE is used as representative in the pseudocode above because handling this situation is generally the most complex. Line 5 adds the current node to existing layer, which will be further verified. Line 6 sets the current node as visited and removes it from NextNodes, which is used to record the nodes that can be traversed in the next step. If the current node is the last node to be traversed, then the pseudocode checks the validity of the last layer and updates *MinLayers if the data transfer is less (see lines 7-8). Otherwise, if the number of consumers of the current node is one, the current node will be added to the existing pipeline (see line 11), and the LayerMapper function will be called to process the consumers of the current node. If the number of consumers of the current node is not one, then the pseudocode verifites the validity of the pipeline. If it is valid, the pseudocode then iteratively sets each node in the NextNodes as the next node in the traversal and launches LayerMapper again (see line 21) such that all the possible paths will be traversed. Although set forth above using recursion, it is appreciated that iterative implementations may be used in addition to or in lieu of recursion.

All simulations were performed using the Tensorflow platform and the Accelerated Linear Algebra (XLA) compiler. In particular, XLA intermediate representations (IRs) were converted to an FPGA instruction stream (also termed “bit stream” above) using the techniques disclosed herein.

The techniques disclosed herein were tested on three extant deep neural networks (DNNs): the Wide & Deep Learning (WDL) DNN, the Long Short-Term Memory (LSTM) DNN with slight modification to use two basic cells as the loop body, and the Residual Neural Network (ResNet).

The optimization methods disclosed herein resulted in reduced data transfer at least as high as 81%; however, the projected efficiency was network-specific. Table 1 shows the results of this example. Table 1 includes the number of primitives in the model, both before (N) and after transformation (N′); the number of unsupported primitives on the device but in the model, both before (UN) and after transformation (UN′); the number of subgraphs split by the unsupported primitives, both before (SG) and after transformation (SG′); the number of layers after mapping (HL); the average number of primitives per layer (APL); the data transfer size with conventional acceleration (DT); the data transfer size after applying the techniques of the present disclosure (Opt); and the reduction in data transfer due to the techniques of the present disclosure (R).

TABLE 1

| | Before Transform | | | After Transform | | | | Layers | | Data Transfer | |
|---|---|---|---|---|---|---|---|---|---|---|---|
| Model | N | UN | SG | N′ | UN′ | SG′ | HL | APL | DT | Opt | R |
| WDL | 11 | 3 | 4 | 11 | 0 | 1 | 4 | 2.8 | 9.4 MB | 1.8 MB | 81% |
| LSTM | 34 | 9 | 4 | 52 | 0 | 1 | 26 | 2 | 9.3 MB | 1.5 MB | 84% |
| ResNet | 44 | 12 | 13 | 44 | 0 | 1 | 13 | 3.4 | 48.7 MB | 3 MB | 94% |

On account of the reduction in data transfer, the performance of WDL was improved, resulting in a 4.8× speedup (end-to-end) as compared to conventional acceleration of WDL without applying the mapping of the present disclosure on the same FPGA design. For LSTM and ResNet, the mapping of the present disclosure achieves a 1.5× and 2.5× speedup, respectively.

Additional simulations used slightly different algorithms for mapping to layers. For example, rather than applying an exhaustive search as in the simulations described above, other simulations used a greed algorithm. In the examples described below, a three-situation greedy algorithm was applied. In particular, the system first determines whether each primitive has (1) a single input and a single consumer, (2) multiple inputs but a single consumer, or (3) multiple consumers (and any number of inputs). For situation (1), the simulations applied Equation 1 below:

DT[i]=min{DT[i−len]+PSeq[i−len+1].in_size, PSeq[i].out_size};

{i ∈ (0, PSeq.siz), j ∈ (0, HL.size), len=HL[j].len Equation 1

In the example of Equation 1, DT is the data transfer associated with a particular grouping i of a sequence PSeq of primitives, all of which are classified within situation (1). HL is the set of layers, and j is the index of layers. Thus, Equation 1 selects the mapping with a lowest associated DT.

For situation (2), the simulations first determine all preceding primitives to a primitive classified in situation (2). If more than one predecessor may not write to off-chip memory, then an error is returned. On the other hand, if one predecessor may not write to off-chip memory, then the subgraph of that predecessor is selected for including the primitive classified as situation (2). If all predecessors may write to off-chip memory, then the data transfer of each possible mapping is determined (e.g., using Equation 1), and the mapping with the lowest associated transfer is selected.

For situation (3), the simulations use each consumer of the primitive with multiple consumers to start a new sequence to which Equation 1 is applied to select a mapping. Thereafter, each consumer sequence is mapped accordingly. Although this three-part algorithm does not always find the most optimal solution, it is generally less complex in time than algorithms that do.

Similar to the mapping algorithm, a greedy algorithm may be applied to schedule the mapped layers, as explained above with respect to step 507. In the simulations presented below, the scheduler schedules any layers in sequential order that are required (e.g., if layer 1 depends only on the output of layer 2, then layer 1 is scheduled before). For layers having multiple inputs, the input layers are first categorized as within an available amount of on-chip memory or without. Any layers without are scheduled before layers that are within. Moreover, within each group of layers that are within/without, any layers that are longer are executed before those that are shorter.

These disclosed herein were tested on three extant deep neural networks (DNNs): the Wide & Deep Learning (WDL) DNN, the Conversion Rate (CVR) DNN, and the Multilayer Perceptron Residual Network (MLP-ResNet).

The optimization methods disclosed herein resulted in reduced data transfer at least as high as 81%; however, the projected efficiency was network-specific. Table 2 shows the results of this example. Table 2 includes the number of primitives in the model, both before (N) and after transformation (N′); the number of unsupported primitives on the device but in the model, both before (UN) and after transformation (UN′); the number of subgraphs split by the unsupported primitives, both before (SG) and after transformation (SG′); the number of layers after mapping (HL); the average number of primitives per layer (APL); the data transfer size with conventional acceleration (DT); the data transfer size after applying the techniques of the present disclosure (Opt); and the reduction in data transfer due to the techniques of the present disclosure (R).

TABLE 2

| | Before Transform | | | After Transform | | | Layers | | | Data Transfer | |
|---|---|---|---|---|---|---|---|---|---|---|---|
| Model | N | UN | SG | N′ | UN′ | SG′ | HL | APL | DT | Opt | R |
| WDL | 11 | 3 | 4 | 11 | 0 | 1 | 4 | 2.8 | 9.4 MB | 1.8 MB | 81% |
| CVR | 25 | 4 | 5 | 25 | 0 | 1 | 16 | 1.6 | 51.3 MB | 14.0 MB | 73% |
| MLP-ResNet | 44 | 12 | 13 | 44 | 0 | 1 | 13 | 3.4 | 48.7 MB | 3.0 MB | 94% |

On account of the reduction in data transfer, the performance of WDL was improved, resulting in a 4.8× speedup (end-to-end) as compared to conventional acceleration of WDL without applying tile mapping of the present disclosure on the same FPGA design. For CVR and MLP-ResNet, the mapping of the present disclosure achieves a 1.55× and 2.5× speedup, respectively.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

Other embodiments will be apparent from consideration of the specification and practice of the embodiments disclosed herein. It is intended that the specification and examples be considered as example only, with a true scope and spirit of the disclosed embodiments being indicated by the following claims.

1. A system for mapping a neural network to a programmable logic devices (PLD), comprising:
at least one memory configured to store instructions; and
at least one processor configured to execute the instructions to cause the system to perform operations comprising:
receiving a data structure defining an architecture of the PLD;
receiving a data structure defining an architecture of the neural network;
partitioning the architecture of the PLD into a plurality of layers, each layer having a starting primitive adjacent to a first off-chip buffer and an ending primitive adjacent to a second off-chip buffer;
mapping the architecture of the neural network onto one or more of the plurality of layers;
scheduling the mapped architecture of the neural network for execution on the one or more of the plurality of layers; and
outputting an execution sequence based on the scheduled and mapped architecture of the neural network.

2. The system of claim 1, wherein the data structure defining the architecture of the neural network comprises a computational graph.

3. The system of claim 2, wherein the computational graph comprises a plurality of primitives and inputs thereto.

4. The system of claim 2 erg, wherein the operations further comprise transforming at least one subgraph comprising one of more primitives to at least one other subgraph according to one or more transformation rules.

5. The system of claim 2, wherein the computational graph includes at least one nested pattern.

6. The system of claim 1, wherein the data structure defining the architecture of the PLD comprises a specification language.

7. The system of claim 1, wherein partitioning the architecture of the PLD comprises applying Dijkstra's algorithm

8. The system of claim 1, wherein partitioning the architecture of the PLD comprises generating possible paths along primitives of the PLD that start and end adjacent to a bus transferring data off-chip, each path comprising one of the plurality of layers.

9. The system of claim 1, wherein mapping the architecture of the neural network onto one or more of the plurality of layers comprises generating possible mappings of primitives of the neural network onto the plurality of layers and selecting the possible mapping having a local minimum of the data transfer size.

10. The system of claim 1, wherein scheduling the mapped architecture of the neural network for execution comprises selecting an execution order for the one or more of the plurality of layers such that the data transfer size is at least locally minimized.

11. The system of claim 10, wherein selecting the execution order comprises generating possible execution orders of the one or more of the plurality of layers and selecting the possible execution order having a local minimum of the data transfer size.

12. The system of claim 10, wherein selecting the execution order comprises application of a greedy algorithm.

13. The system of claim 10, wherein at least one step of the execution order comprises a partial write to off-chip memory and a partial write to on-chip memory.

14. The system of claim 1, wherein the execution sequence comprises a bit stream for input to the PLD.

15. The system of claim 1, wherein the PLD comprises a field-programmable gate array (FPGA).

16. A method for mapping a neural network to a programmable logic device (PLD), comprising:
receiving a data structure defining an architecture of the PLD;
receiving a data structure defining an architecture of the neural network;
partitioning the architecture of the PLD into a plurality of layers, each layer having a starting primitive adjacent to a first off-chip buffer and an ending primitive adjacent to a second off-chip buffer;
mapping the architecture of the neural network onto one or more of the plurality of layers;
scheduling the mapped architecture of the neural network for execution on the one or more of the plurality of layers; and
outputting an execution sequence based on the scheduled and mapped architecture of the neural network.

17. The method of claim 16, wherein the data structure defining the architecture of the neural network comprises a computational graph.

18. The method of claim 17, wherein the computational graph comprises a plurality of primitives and inputs thereto.

19. The method of claim 17, further comprising transforming at least one subgraph comprising one or more primitives to at least one other subgraph according to one or more transformation rules.

20. The method of claim 17, wherein the computational graph includes at least one nested pattern.

21. The method of claim 16, wherein the data structure defining the architecture of the PLD comprises a specification language.

22. The method of claim 16, wherein partitioning the architecture of the PLD comprises applying Dijkstra's algorithm.

23. The method of claim 16, wherein partitioning the architecture of the PLD comprises generating possible paths along primitives of the PLD that start and end adjacent to a bus transferring data off-chip, each path comprising one of the plurality of layers.

24. The method of claim 16, wherein mapping the architecture of the neural network onto one or more of the plurality of layers comprises generating possible mappings of primitives of the neural network onto the plurality of layers and selecting the possible mapping having a local minimum of the data transfer size.

25. The method of claim 16, wherein scheduling the mapped architecture of the neural network for execution comprises selecting an execution order for the one or more of the plurality of layers such that the data transfer size is at least locally minimized.

26. The method of claim 25, wherein selecting the execution order comprises generating possible execution orders of the one or more of the plurality of layers and selecting the possible execution order having a local minimum of the data transfer size.

27. The method of claim 25, wherein selecting the execution order comprises application of a greedy algorithm.

28. The method of claim 25, wherein at least one step of the execution order comprises a partial write to off-chip memory and a partial write to on-chip memory.

29. The method of claim 16, wherein the execution sequence comprises a bit stream for input to the PLD.

30. A non-transitory computer-readable storage medium storing a set of instructions that is executable by one or more processors to cause the one or more processors to perform a method for mapping a neural network to a programmable logic device (PLD), the method comprising:
receiving a data structure defining an architecture of the PLD;
receiving a data structure defining an architecture of the neural network;
partitioning the architecture of the PLD into a plurality of layers, each layer having a starting primitive adjacent to a first off-chip buffer and an ending primitive adjacent to a second off-chip buffer;
mapping the architecture of the neural network onto one or more of the plurality of layers such that a data transfer size is at least locally minimized;
scheduling the mapped architecture of the neural network for execution on the one or more of the plurality of layers; and
outputting an execution sequence based on the scheduled and mapped architecture of the neural network.
